(19) United States
(12) Patent Application Publication
(10) Pub. No.: US 2024/0409460 A1
(43) Pub. Date: Dec. 12, 2024

(54) RECYCLED PLASTIC FIBERS FOR REINFORCING AND ACCELERATING HYDRATION OF CEMENTITIOUS-BASED MATERIALS

(71) Applicants: Chad JOHNSON, Ellensburg, WA (US); Jon BELKOWITZ, Howell, NJ (US)

(72) Inventors: Chad JOHNSON, Ellensburg, WA (US); Jon BELKOWITZ, Howell, NJ (US)

(21) Appl. No.: 18/740,946

(22) Filed: Jun. 12, 2024

Related U.S. Application Data
(60) Provisional application No. 63/507,511, filed on Jun. 12, 2023.
(60) Provisional application No. 63/508,324, filed on Jun. 15, 2023.

(51) Int. Cl. C04B 18/24; C04B 28/00; C04B 40/00

(52) U.S. Cl. CPC C04B 18/248; C04B 18/24; C04B 28/00; C04B 40/0046

(57) ABSTRACT

A method for manufacturing concrete from waste plastic. The waste plastic may be in the form of used baling twine. The used baling twine may contain residue from the baled material, such as hay, alfalfa, or other animal fodder, for example. This organic residue may include cellulose fibers, sugars, and alkalis from the fodder. Baling twine may be processed into a fiber which is then mixed into the cementitious mixture. Concrete made from such a mixture may have improved mechanical performance due to the included organic residue, such as increased tensile strength and energy absorption capabilities, for example.

### CROSS-REFERENCE TO RELATED APPLICATION

This application claims the benefit of priority of each of U.S. provisional patent application No. 63/507,511, titled “RECYCLED PLASTIC FIBERS FOR REINFORCING AND ACCELERATING HYDRATION OF CEMENTITIOUS-BASED MATERIALS,” filed on Jun. 12, 2023, and U.S. provisional patent application No. 63/508,324, titled “RECYCLED PLASTIC FIBERS FOR REINFORCING AND ACCELERATING HYDRATION OF CEMENTITIOUS-BASED MATERIALS,” filed on Jun. 15, 2023, each of which is incorporated herein in its entirety by this reference.

### FIELD

An exemplary embodiment relates to the field of fiber-reinforced cementitious mixtures.

### BACKGROUND

Plastic waste is becoming increasingly prevalent in modern society and may originate from various sources. Different fields such as agriculture, industrial manufacturing, tourism, and medicine may all produce plastic waste as a byproduct. Production and consumption of plastic products has been increasing consistently in recent times and presents a major environmental issue. A solution to this issue is recycling. Recyclable plastic is collected and then re-used to create other plastic based products, however, not all plastic is recyclable. Despite best efforts to recycle, a large amount of plastic still ends up in landfills and oceans.

In the construction industry, there is always demand for cheaper, lighter concrete materials that retain their resilience while reducing weight. Construction materials have incorporated particles into the concrete for weight reduction. For example, concrete can be mixed with rubber or another filling material in order to reduce the weight of the concrete. However, light-weight concrete compositions typically sacrifice strength and resilience in favor of reducing weight.

### SUMMARY

According to at least one exemplary embodiment, a method, system and apparatus for a concrete fiber manufactured from waste plastic may be shown and described. In particular, the waste plastic used may be baling twine used for hay or alfalfa and other animal fodder. Used baling twine often retains the cellulose fibers, sugars, and alkalis from the fodder. Baling twine may be manufactured into fibers which can be mixed into concrete and other cementitious-based materials while the concrete is still fresh and elastic.

By manufacturing the baling twine into fiber with the fodder manufacturing residue, the sugars, alkalis, and cellulose may be embedded in the fiber and may serve as nucleation sites for cementitious hydration. The nucleation at the interfacial zone of the fiber and cementitious matrix mechanically and chemically anchors the fiber into the concrete composite. The fibers made from baling twine with the fodder manufacturing residue may improve mechanical performance of the concrete in various aspects including tensile strength, energy absorption, and the like.

According to at least one exemplary embodiment, a method, system and apparatus for a novel concrete or cementitious mixture may be shown and described. In an exemplary embodiment, residue from the manufacturing of fodder may be used in a cementitious mixture. For example, the fodder manufacturing residue may be mixed with plastic or another aggregate, which may then be integrated into a cementitious mixture for forming concrete. It may be contemplated that the fodder residue is retrieved from equipment and systems used for producing the fodder. A vacuum may be used to remove the fodder from the equipment and into a receptacle. Vacuumed fodder can then be mixed with an aggregate such as by using an industrial mixer. The aggregate mixed with the residue can then be mixed into the cement.

Fodder manufacturing residue may provide several advantages when mixed with cement. For example, residue from the fodder may retain concentrated amounts of cellulose fibers, sugars, and alkalis. The cellulose, sugar, and alkali may be embedded in or absorbed by the aggregate. When the aggregate is mixed with the cement, the cellulose, sugar, and alkali in the aggregate may act as nucleation sites for cementitious hydration. The nucleation at the interfacial zone of the fiber and the cementitious matrix mechanically and chemically anchors the aggregate into the cementitious mixture when it dries into concrete. Mechanical performance of the concrete may be improved giving the ensuing concrete a greater tensile strength and energy absorption capability.

The aggregate may be formed from, for example, recycled plastic. Alternatively, the aggregate may include plastic fibers intended for mixing with concrete, such as, for example, polypropylene, e-glass, or polyvinyl, among others. A plastic, e-glass, or cellulose based fiber may compose 80-98% of the aggregate, where the remaining 2-20% weight by volume may be composed of fodder production waste. The aggregate and fodder production residue may be mixed in a rotary mixture, for example, for a period of 30-60 minutes as required to obtain a homogeneous mixture of aggregate and fodder residue. It may be contemplated that shredded baling twine may be used as the aggregate and may already be embedded with organic materials such as cellulose, sugar, and alkalis, which may be absorbed from the bales. Other plastics containing organic material may be contemplated.

According to at least one embodiment, a method of manufacturing concrete includes receiving fiber material comprising plastic, mixing fiber of the fiber material with fodder manufacturing residue, and combining, with a cementitious mixture, the mixed fiber of the fiber material and fodder manufacturing residue.

Receiving fiber material may include reducing twine comprising plastic into fibers.

The twine may consist of or include baling twine.

Reducing twine comprising plastic into fibers may include grinding the baling twine through a screen to obtain the fibers and cutting the obtained fibers.

The baling twine may have organic residue of a baled product.

The baled product may be one or more of hay, alfalfa, and animal fodder.

The baling twine may include, from the organic residue of the baled product, at least one of cellulose fibers, sugars, and alkalis.

The organic residue is embedded in the fibers and acts as nucleation sites, wherein the nucleation sites anchor the fiber into a concrete composite formed by curing the cementitious mixture thereby improving mechanical performance, for example by increasing tensile strength and/or increasing energy absorption capability.

According to at least one embodiment, a method of making a cementitious mixture includes manufacturing fodder, retrieving fodder residue, mixing the fodder residue with an aggregate, and mixing the fodder-aggregate mixture into cement.

Manufacturing fodder may include at least one of an agricultural process and an industrial process.

Manufacturing fodder may include fodder residue accumulating on at least one asset used during the at least one of an agricultural process and an industrial process, the at least one asset including at least one of equipment, tools, and storage components.

Retrieving fodder residue may include retrieving fodder residue accumulated on the at least one asset.

Retrieving fodder residue accumulated on the at least one asset may include at least one of using a vacuum device and scraping.

Mixing the fodder residue with an aggregate may include the aggregate absorbing the fodder residue thereby becoming embedded with at least one component of the fodder residue, the at least one component includes at least one of cellulose, sugars, and alkaline.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary schematic flowchart illustrating a method associated with an exemplary embodiment.

FIG. 2 is an exemplary embodiment of a schematic flowchart of a process for implementing an exemplary embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

An exemplary embodiment may provide an improved concrete formed using waste plastic. In particular, used baling twine may be mixed in with a cementitious composite to form a concrete with improved tensile strength and energy absorption. Further, the concrete can include recycled waste plastic that would otherwise occupy a landfill. By manufacturing the bailing twine into fiber with the fodder manufacturing residue, the sugars, alkalis, and cellulose embeds in the fiber and acts as nucleation sites for cementitious hydration. This nucleation at the interfacial zone of the fiber and the cementitious matrix mechanical and chemically anchors the fiber into the concrete composite.

An exemplary embodiment may begin by receiving used baling twines or other waste plastics with the appropriate cellulose fibers. The baling twine may then be manufactured into fibers in its used state. That is, the baling twine may be manufactured into the fibers directly after being used for baling so that it retains the cellulose fibers, sugars, and alkalis absorbed from the fodder or other baled material. In an exemplary embodiment, the baling twine may be ground through a screen at a particular cut rate and feed rate to receive appropriately sized fibers. For example, the twine may be ground through a 2″ screen and then cut to obtain fibers between 0.05″ and 1.25″ in length. Then, the baling twine fibers can be mixed into a cementitious compound in order to produce a lighter concrete with a greater tensile strength and increased energy absorption capability.

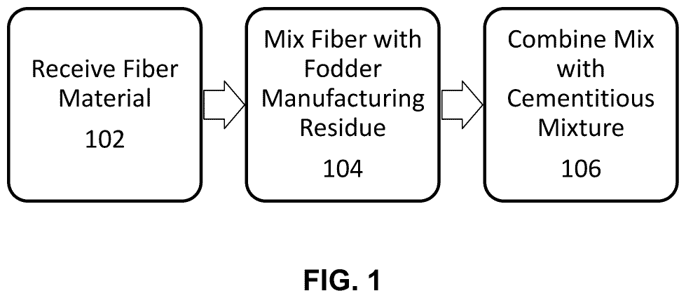

FIG. 1 may illustrate a schematic flowchart representing an exemplary method according to an embodiment. An exemplary embodiment may begin by receiving fiber material in step 102. For example, an embodiment may include receiving a cellulose-based fiber. An exemplary fiber may be 80-98% weight by volume of fiber while the remaining 2-20% weight by volume is fodder production waste. This might be obtained from, for example, used baling twine which might have some residue of the baled product leftover. Fodder manufacturing residue may be obtained by a vacuum system which may gather the residue from hay export facilities and machinery. Conventional processed fibers may optionally be mixed with fodder manufacturing residue in a rotary mixer in step 104 for a period of time, such as, for example, 30 to 60 minutes, in order to use conventional fiber that was not used for baling and to further embed organic material from the fodder residue into otherwise clean fibers. After producing the mixture in step 104, the materials may be retrieved from the mixer to obtain a homogenous fiber embedded with the fodder manufacturing residue.

The homogenous fiber may contain small amounts of the waste from the baling twine, including the cellulose fibers, sugars, and alkalis from the baled fodder. The fiber and fodder manufacturing residue mix made in step 4 can then be combined, in step 106, into a cementitious mixture while the cement is fresh in a plastic state. The organic residue may be embedded in the fiber, acting as nucleation sites for cementitious hydration. The nucleation at the interfacial zone of the fiber and cementitious mixture may mechanically and chemically anchor the fiber into the concrete composite. Fibers made from baling twine with organic residue may improve mechanical performance in areas such as tensile strength, energy absorption, and the like.

An exemplary embodiment may provide an improved cementitious mixture and a method for forming such a mixture. In an exemplary embodiment, residue from the manufacturing of fodder or any other organic material may be used in a cementitious mixture. For example, the fodder manufacturing residue may be mixed with plastic or another aggregate, which may then be integrated into a cementitious mixture for forming concrete. It may be contemplated that the fodder residue is retrieved from equipment and systems used for producing the fodder. A vacuum may be used to remove the fodder from the equipment and into a receptacle. Vacuumed fodder can then be mixed with an aggregate such as by using an industrial mixer. The aggregate mixed with the residue can then be mixed into the cement. The aggregate may be formed from, for example, as described in the preceding

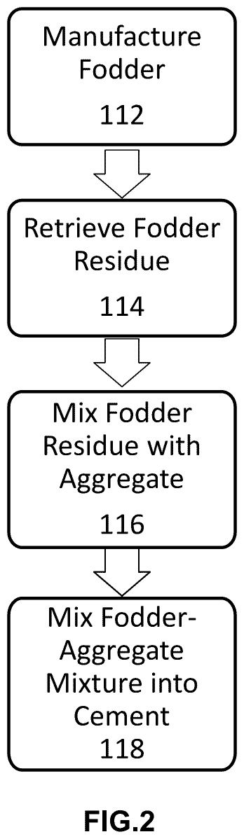

Referring now to a second exemplary embodiment, in FIG. 2 may provide a schematic flowchart illustrating a method for implementing an exemplary embodiment. In an optional first step, fodder may be manufactured, represented as step 112. Fodder may be manufactured via agricultural or industrial processes. Residue from the manufacture of the fodder may accumulate on various equipment, tools, and storage components used throughout the manufacturing process.

This leftover residue may be retrieved, represented as step 114, for example, using a vacuum device and/or by scraping the residue from the surface. The retrieved residue accumulation may then be mixed with an aggregate, represented as step 116. In an exemplary embodiment, the residue may be mixed in an industrial mixer with the aggregate for a period of, for example, 30-60 minutes. The aggregate may absorb the fodder residue, and may thus become advantageously embedded with the cellulose, sugars, and alkaline found in the fodder. The fodder residue-aggregate mixture may then be introduced into a cement, represented as step 118. The cement may thus incorporate the advantageous effects of the organic materials embedded in the aggregate by the fodder manufacturing residue.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of manufacturing concrete comprising:
receiving fiber material comprising plastic;
mixing fiber of the fiber material with fodder manufacturing residue; and
combining, by mixing, the mixed fiber a fodder manufacturing residue with a cementitious mixture.

2. The method according to claim 1, wherein the fiber material comprises cellulose-based fiber.

3. The method according to claim 1, wherein receiving fiber material comprises reducing twine comprising plastic into fibers.

4. The method according to claim 3, wherein the twine comprises baling twine.

5. The method according to claim 4, wherein reducing twine comprising plastic into fibers comprises grinding the baling twine through a screen to obtain the fibers and cutting the obtained fibers.

6. The method according to claim 4, wherein the baling twine comprises organic residue of a baled product.

7. The method according to claim 4, wherein the baled product comprises at least one of hay, alfalfa, and animal fodder.

8. The method according to claim 7, wherein the baling twine comprises, from the organic residue of the baled product, at least one of cellulose fibers, sugars, and alkalis.

9. The method according to claim 8, wherein the organic residue is embedded in the fibers and acts as nucleation sites, wherein the nucleation sites anchor the fiber into a concrete composite formed by curing the cementitious mixture thereby improving mechanical performance.

10. The method according to claim 9, wherein improving mechanical performance comprises at least one of increasing tensile strength and increasing energy absorption capability.

11. The method according to claim 1, wherein the fiber material comprises fiber and fodder production waste.

12. The method according to claim 11, further comprising obtaining the fodder production waste from hay.

13. The method according to claim 12, wherein obtaining the fodder production waste from hay comprises gathering the fodder production waste using a vacuum system.

14. The method according to claim 13, further comprising embedding organic material from the fodder production waste into the fiber material.

15. A method of making a cementitious mixture, the method comprising:
manufacturing fodder;
retrieving fodder residue;
mixing the fodder residue with an aggregate; and
mixing the fodder-aggregate mixture into cement.

16. The method according to claim 15, wherein manufacturing fodder comprise at least one of an agricultural process and an industrial process.

17. The method according to claim 16, wherein manufacturing fodder comprises fodder residue accumulating on at least one asset used during the at least one of an agricultural process and an industrial process, the at least on asset comprising at least one of equipment, tools, and storage components.

18. The method according to claim 16, wherein retrieving fodder residue comprises retrieving fodder residue accumulated on the at least one asset.

19. The method according to claim 18, wherein retrieving fodder residue accumulated on the at least one asset comprises at least one of using a vacuum device and scraping.

20. The method according to claim 15, wherein mixing the fodder residue with an aggregate comprises the aggregate absorbing the fodder residue thereby becoming embedded with at least one component of the fodder residue, the at least one component comprising at least one of cellulose, sugars, and alkaline.
